(19) United States
(12) Patent Application Publication
(10) Pub. No.: US 2026/0160490 A1
(43) Pub. Date: Jun. 11, 2026

(54) DRYING DEVICE, DRYING SYSTEM, DRYING METHOD AND SYNTHETIC REACTION SYSTEM

(71) Applicant: CHEMLEX PTE. LTD., SINGAPORE (SG)

(72) Inventors: Xiangxiang LI, SINGAPORE (SG); Haibin XU, SINGAPORE (SG); Chao LU, SINGAPORE (SG); Yanqing YU, SINGAPORE (SG)

(73) Assignee: CHEMLEX PTE. LTD., SINGAPORE (SG)

(21) Appl. No.: 18/970,896

(22) Filed: Dec. 6, 2024

(51) Int. Cl. F26B 3/04; F26B 21/00

(52) U.S. Cl. CPC F26B 3/04; F26B 21/006; F26B 21/50

(57) ABSTRACT

The present disclosure provides a drying device, a drying system, a drying method and a synthetic reaction system. The drying device is used for processing a sample in a sample container and comprises a drying assembly and a first casing, wherein the drying assembly is provided inside the first casing, the sample container is placed inside the first casing, and the drying assembly is located above the sample container; the drying assembly comprises a drying pipe assembly, which comprises a gas channel, a first liquid channel and a liquid guide channel. The present disclosure may improve the drying effectiveness and efficiency, and avoid cross contamination at the same time.

### FIELD

The present disclosure relates to the field of sample processing equipment technology, and in particular to a drying device, a drying system, a drying method and a synthetic reaction system.

### BACKGROUND OF THE DISCLOSURE

Sample drying is a conventional operation process in analytic experiments on chemistry, biology, environmentology and the like. The blow-drying device is used to blow and dry the surface of the sample by nitrogen, other inert gases and air to achieve the purpose of drying the sample rapidly without deteriorating the properties of the sample. In normal cases, in the process of sample drying, the sample in the test tube may attach to the inner wall of the test tube due to the blowing gas, or the sample may be carried out by the blowing gas. This process not only affects the effectiveness and efficiency of drying treatment, but also further affects the treatment effect of subsequent processes.

### BRIEF SUMMARY OF THE DISCLOSURE

To overcome the above problems in the prior art, the present disclosure provides a drying device, a drying system, a drying method and a synthetic reaction system, which retain the dried sample in the bottom of the sample container to a great extent, improve the drying effectiveness and efficiency, and avoid cross-contamination among components such as gas channels and liquid channels. The technical solutions disclosed by the present disclosure are as follows:

According to an aspect of one embodiment disclosed in the present disclosure, a drying device, which is used for processing a sample in a sample container, the drying device comprises a drying assembly and a first casing, the drying assembly is provided inside the first casing, the sample container is placed inside the first casing, and the drying assembly is located above the sample container;
the drying assembly comprises a drying pipe assembly, the drying pipe assembly comprises a gas channel, a first liquid channel and a liquid guide channel, the gas channel is used for conveying a target gas to the sample container, the first liquid channel and the liquid guide channel are used for conveying a target liquid to the sample container, the liquid guide channel is used for indicating an output direction of the target liquid to the sample container, and the gas channel passes through the first liquid channel; along a flow direction of the target liquid, the first liquid channel and the liquid guide channel are arranged in sequential communication; and
the target gas is used for blowing and drying the sample in the sample container, and the target liquid is used for dissolving the sample attached to an inner wall of the sample container.

Optionally, the drying device further comprises a first fixing piece, the first fixing piece is provided on an inner wall of the first casing, the drying assembly is provided on the first fixing piece, and the first fixing piece is provided with a second gas inlet connection and a gas outlet connection;
the drying pipe assembly further comprises a first gas inlet connection, a gas outlet end of the first gas inlet connection is communicated with a gas inlet end of the gas channel, the gas outlet connection is connected with a gas inlet end of the first gas inlet connection, the second gas inlet connection is connected with a gas feed end, and the gas feed end is used for feeding the target gas to the drying device; and
the gas outlet connection is also provided with a valve, and the valve is used for regulating a gas flow passing through the gas outlet connection.

Optionally, the drying device further comprises a second fixing piece, the second fixing piece is provided on an inner wall of the first casing, and the second fixing piece is provided with a connecting head; and
the drying pipe assembly further comprises a liquid inlet connection and a second liquid channel, a liquid outlet end of the second liquid channel is communicated with a liquid inlet end of the first liquid channel, a liquid inlet end of the second liquid channel is communicated with one end of the liquid inlet connection, one end of the connecting head is connected with the other end of the liquid inlet connection, and the other end of the connecting head is connected with a feed end of the target liquid.

Optionally, the drying device further comprises a gas channel casing, a liquid channel casing and a liquid guiding member, the gas channel casing forms the gas channel, and the first liquid channel is formed between the gas channel casing and the liquid channel casing, the liquid channel casing and the liquid guiding member are sequentially arranged, spaced apart from each other on the gas channel casing, the liquid guiding member is provided on the gas channel and closes to a gas outlet end of the gas channel, and the liquid guide channel is formed between the liquid channel casing and the liquid guiding member; and
the liquid guiding member comprises a guide portion, the liquid guide channel is formed between the liquid channel casing and the guide portion, and the guide portion has a shape of a frustum of a cone.

Optionally, the drying assembly further comprises a fixing assembly, a driving device and a first fixing piece, the fixing assembly is provided on the first fixing piece, the driving device is connected with the drying pipe assembly, and a guide part is provided on the fixing assembly; and the driving device is used for driving the drying pipe assembly to move along the guide part.

Optionally, the driving device comprises a first moving assembly, a first transmission assembly and a first driving mechanism, the first moving assembly is connected with the drying pipe assembly, the first transmission assembly is provided at one end of the first moving assembly, and the first moving assembly is in driving connection with the first driving mechanism through the first transmission assembly;
the first moving assembly comprises a drive rod, a moving part and a connecting part, the moving part is connected with the drying pipe assembly, the first transmission assembly is provided at one end of the drive rod, the moving part is sleeved on the drive rod, the connecting part is connected with the fixing assembly, the connecting part is provided at either end of the drive rod, and the connecting part is rotationally connected with the drive rod; and the first driving mechanism is used for driving the moving part to move along the guide part, so as to drive the drying pipe assembly to move; and
the first transmission assembly comprises a transmission wheel, the transmission wheel is provided at one end of the drive rod, the drive rod is in driving connection with the first driving mechanism through the transmission wheel, and the transmission wheel and the connecting part are coaxially arranged with the drive rod.

Optionally, the transmission wheel comprises a driving wheel and a driven wheel, and the first transmission assembly further comprises a transmission belt, the driven wheel is provided at one end of the drive rod, the driving wheel is in driving connection with the first driving mechanism, the driven wheel and the connecting part are coaxially arranged with the drive rod, the driving wheel and the driven wheel are horizontally arranged, and the transmission belt is wound on outer sides of the driving wheel and the driven wheel.

Optionally, the drying device further comprises a first sensing element and a first sensor, at least one of the first sensing element and the first sensor is provided on the drying assembly, and the other is provided on the fixing assembly, and the first sensing element and the first sensor are correspondingly arranged; and the first sensing element and the first sensor are used for sensing that the drying pipe assembly is located at a first preset position.

Optionally, the drying device further comprises a second moving assembly and a receiving cell, the second moving assembly comprises a moving plate, a second transmission assembly and a second driving mechanism, the moving plate is provided inside the first casing, the receiving cell is provided on the moving plate, the receiving cell is used for placing the sample container, the moving plate is in driving connection with the second driving mechanism through the second transmission assembly, a slideway is provided in the bottom of the first casing, and the second driving mechanism is used for driving the moving plate to slide along the slideway; and
the second transmission assembly comprises a gear and a rack, the gear is in driving connection with the second driving mechanism, the rack is provided in the bottom of the first casing, and the gear is engaged with the rack.

Optionally, the drying device further comprises a second sensing element and a second sensor, at least one of the second sensing element and the second sensor is provided on the moving plate, the other is provided on the inner wall of the first casing, and the second sensing element and the second sensor are correspondingly arranged; and the second sensing element and the second sensor are used for sensing that the moving plate is located at a second preset position.

Optionally, the drying device further comprises a heating device, the heating device is provided on the receiving cell, and the heating device is used for heating the sample container accommodated in the receiving cell.

According to a further aspect of one embodiment disclosed in the present disclosure, a drying system, comprising a recovery device and the drying device, the first casing is configured with a connecting port, and the recovery device is communicated with the drying device through the connecting port;
the recovery device comprises a third gas inlet connection, a power transmission device and a second casing, the third gas inlet connection is communicated with the connecting port, the third gas inlet connection is provided on an outer side of the second casing, one end of the power transmission device is provided inside the second casing, and the other end of the power transmission device is provided outside the second casing; and the power transmission device is provided with a cellular structure at the end located inside the second casing; and
the third gas inlet connection is used for conveying an organic gas produced in the drying device to the second casing, the power transmission device is used for providing power for the flow of the organic gas, and the cellular structure is used for stabilizing the gas flow in the second casing.

Optionally, the power transmission device comprises a vacuum pipe and a vacuum pump, the vacuum pipe comprises a first portion and a second portion, the first portion is provided inside the second casing, the second portion passing through the second casing is connected with the vacuum pump, and one end of the first portion that is far away from the second portion is provided with the cellular structure; and the vacuum pipe is an L-shaped pipe.

Optionally, the recovery device further comprises a condensing structure, a receiving structure and a third fixing piece, the condensing structure is provided inside the second casing, the receiving structure is provided below the second casing, the third fixing piece is sleeved on the second casing, the third fixing piece is in fixed connection with an outer side of the first casing, and one end of the power transmission device is provided inside the condensing structure; and
the condensing structure is used for condensing the organic gas in the second casing into liquid, and the receiving structure is used for receiving the liquid formed by condensation.

According to a further aspect of one embodiment disclosed in the present disclosure, a drying method based on the drying system is provided, the recovery device comprises the condensing structure and the receiving structure, and the method comprises the following steps:
conveying the target gas to the sample container of the drying device along the gas channel to blow the sample container of the sample;
during the blowing process, conveying the target liquid to the sample container along the first liquid channel and the liquid guide channel, so as to dissolve the sample attached to the inner wall of the sample container; and
during the blowing process, conveying the organic gas produced in the drying device to the second casing through the power transmission device of the recovery device, the connecting port of the drying device and the third gas inlet connection of the recovery device; and condensing the organic gas into liquid through the condensing structure, and receiving the liquid formed by condensation through the receiving structure; and the power transmission device is provided with the cellular structure at one end located inside the second casing.

According to a further aspect of one embodiment disclosed in the present disclosure, a synthetic reaction system is provided, which comprises the drying system.

The technical solutions provided in embodiments disclosed in the present disclosure have at least the following beneficial effects:

The present disclosure provides a drying device, a drying system, a drying method and a synthetic reaction system. The drying device is used for processing a sample in a sample container, the drying device comprises a drying assembly and a first casing, the drying assembly is provided inside the first casing, the sample container is placed inside the first casing, and the drying assembly is located above the sample container. Wherein the drying assembly comprises a drying pipe assembly, the drying pipe assembly comprises a gas channel, a first liquid channel and a liquid guide channel, the gas channel is used for conveying a target gas to the sample container, the first liquid channel and the liquid guide channel are used for conveying a target liquid to the sample container, the liquid guide channel is used for indicating an output direction of the target liquid to the sample container, and the gas channel passes through the first liquid channel; and along a flow direction of the target liquid, the first liquid channel and the liquid guide channel are arranged in sequential communication, the target gas is used for blowing the sample container of the sample, and the target liquid is used for dissolving the sample attached to an inner wall of the sample container. During the process of drying the sample in the sample container based on the drying device, the target gas is conveyed to the sample container for drying treatment through the gas channel in the drying pipe assembly, the target liquid flows to the liquid guide channel through the first liquid channel, and is dispersed and sprayed to the sample container along an output direction indicated by the liquid guide channel after being pressurized through the liquid guide channel, so as to dissolve the sample attached to the inner wall of the sample container during the drying process and clean the inner wall of the container. Additionally, the dissolved sample will flow to the bottom of the sample container for the next drying operation, so that the sample is not taken out during the drying process, and the dried sample is retained in the bottom of the sample container to the maximum extent. In this way, the drying effectiveness and efficiency are improved, and cross contamination among components such as gas channels and liquid channels is avoided.

It should be understood that the foregoing general description and the description in the following paragraphs are merely exemplary and explanatory, and are not intended to limit the present disclosure.

### BRIEF DESCRIPTION OF THE DRAWINGS

The drawings herein, which are incorporated into the Description and form a part of the Description, show the embodiments consistent with the present disclosure, and are used together with the Description to explain the principles of the present disclosure but not be construed as unduly limiting the present disclosure.

FIG. 1 is a sectional structure view of a drying pipe assembly provided by an embodiment of the present application;

FIG. 2 is an exploded structure view of a drying assembly provided by an embodiment of the present application;

FIG. 3 is a structural diagram of the drying assembly provided by an embodiment of the present application;

FIG. 4 is a structural diagram of installation of the drying assembly provided by an embodiment of the present application from one perspective;

FIG. 5 is a structural diagram of installation of the drying assembly provided by an embodiment of the present application from another perspective;

FIG. 6 is a structural diagram of a second moving assembly provided by an embodiment of the present application;

FIG. 7 is a structural diagram of a drying device provided by an embodiment of the present application;

FIG. 8 is a structural diagram of a vacuum pipe provided by an embodiment of the present application;

FIG. 9 is a schematic diagram of a recovery device provided by an embodiment of the present application; and

FIG. 10 is a sectional structure view of the recovery device provided by an embodiment of the present application;

### DETAILED DESCRIPTION OF THE DISCLOSURE

The technical solutions in the embodiments of the present application will be clearly and completely described below in conjunction with the drawings in the embodiments of the present application. Apparently, the embodiments described are only some, not all of the embodiments of the present application. Based on the embodiments in the present application, all other embodiments obtained by those of ordinary skill in the art without any creative work also belong to the scope of protection of the present application.

It should be noted that the term “embodiment” or “embodiments” referred in the Description of the present application refers to a specific feature, structure, or characteristic that can be included in at least one implementation of the present application. For Description, Claims and the accompanying drawings of the present application, it should be understood that orientation or position relations indicated by the terms “above”, “under”, “top”, “bottom”, etc. are based on the orientation or position relations shown in the drawings, and are only used to describe the present application and simplify description herein but not to indicate or imply that the device or component indicated must have a specific orientation and be constructed and operated in a specific orientation. Therefore, they shall not be construed as a limitation to the present application. Terms “first” and “second” are only used for description, but cannot be understood to indicate or imply relative importance or implicitly indicate the number of technical features described. Therefore, features defined as “first” and “second” may include one or more of these features explicitly or implicitly. Moreover, the terms, including “first”, “second” and the like, are intended to distinguish the similar objects, instead of describing a specific sequence or a precedence order. It should be understood that the data used in such a way can be exchanged where appropriate, so that the embodiments of the present application described herein can be implemented in addition to those illustrated or described herein. In addition, in the description of the present embodiment, “a plurality of” means two or more, unless otherwise specified. Additionally, the intent of terms of “comprise” and “have” and any variant forms thereof is to cover a non-exclusive inclusion; for example, the processes, methods, systems or products containing a series of steps or units are not limited to listing all of these steps or units clearly, but containing other steps or units not clearly listed or inherent to these processes, methods, products or equipment.

The embodiments of the present application will be further described in detail in combination with drawings and embodiments for clear understanding of the purpose, technical solutions and advantages of the embodiments of the present application. It should be understood that specific embodiments described herein are only used to explain the embodiments of the present application rather than define the embodiments of the present application.

In the field of pharmaceutical chemistry and synthesis, products of synthetic reaction need post-treatment, blow-drying is widely used as an effective operation for drying the products. With the development of automation in pharmaceutical synthesis reaction, the manual blowing-and-drying operation can no longer meet the requirements of full automation-based pharmaceutical chemistry and synthesis. Therefore, the present disclosure provides an automatic drying device, which achieves unmanned blowing-and-drying operation to ensure the safety during the experimental process and seamless connection with the automatic processes before and after the current process. Also, an operation of dissolving by spraying liquid is added to ensure the sample integrity and the convenience of disengaging products in the next stage, thus improving the production efficiency.

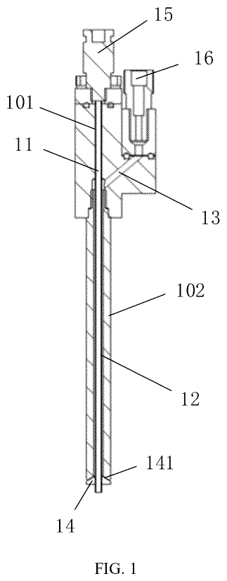

The technical solutions of the embodiments of the present application will be described in detail with reference to the FIGS. 1 to 10.

Referring FIGS. 1 to 7, one embodiment of the present application provides a drying device for processing a sample in a sample container 64. The drying device comprises a drying assembly and a first casing 61, the drying assembly is provided inside the first casing 61, the sample container 64 is placed inside the first casing 61, and the drying assembly is located above the sample container 64; the drying assembly comprises a drying pipe assembly, the drying pipe assembly comprises a gas channel 11, a first liquid channel 12 and a liquid guide channel 141, the gas channel 11 is used for conveying a target gas to the sample container 64, the first liquid channel 12 and the liquid guide channel 141 are used for conveying a target liquid to the sample container 64, the liquid guide channel 141 is used for indicating an output direction of the target liquid to the sample container 64, and the gas channel 11 passes through the first liquid channel 12; along a flow direction of the target liquid, the first liquid channel 12 and the liquid guide channel 141 are arranged in sequential communication; and the target gas is used for blowing and drying the sample in the sample container 64, and the target liquid is used for dissolving the sample attached to an inner wall of the sample container 64.

Specifically, the target gas may comprise nitrogen, other inert gases and air. In practical application, nitrogen or other inert gases are conveyed for blowing and drying samples that need to be isolated from air, and air is used for blowing and drying other samples. There is no special restriction on selection of the target liquid. It can be selected from the liquids dissolving the sample according to the experimental requirements and the sample properties.

Optionally, as shown in FIG. 1, the drying device further comprises a gas channel casing 101, a liquid channel casing 102 and a liquid guiding member 14, the gas channel casing 101 forms the gas channel 11, and the first liquid channel 12 is formed between the gas channel casing 101 and the liquid channel casing 102, the liquid channel casing 102 and the liquid guiding member 14 are sequentially arranged, spaced apart from each other on the gas channel casing 101, the liquid guiding member 14 is provided on the gas channel 11 and closes to a gas outlet end of the gas channel 11, and the liquid guide channel 141 is formed between the liquid channel casing 102 and the liquid guiding member 14; and the liquid guiding member 14 comprises a guide portion, the liquid guide channel 141 is formed between the liquid channel casing 102 and the guide portion, and the guide portion has a shape of a frustum of a cone.

In one specific embodiment, the first liquid channel 12 is sleeved on the gas channel 11. Preferably, the first liquid channel 12 and the gas channel 11 may be coaxial pipelines, a liquid outlet end of the first liquid channel 12 and the guide portion are correspondingly arranged in structure, one of the guide portion and the liquid outlet end of the first liquid channel 12 has a protrusion structure and the other has a corresponding depressed structure. The target liquid enters the first liquid channel 12 and flows to the liquid outlet end of the first liquid channel 12. After being pressurized under the guidance of the liquid guiding member 14, the target liquid is dispersed and sprayed onto an inner wall of the sample container 64 from between the liquid guiding member 14 and the liquid channel casing 102 (namely, the liquid guide channel 141) in the direction indicated by the guide portion, so as to achieve the effect of dissolving the sample attached to the inner wall of the sample container 64.

Optionally, as shown in FIGS. 4 and 5, the drying device further comprises a first fixing piece 31, the first fixing piece 31 is provided on an inner wall of the first casing 61, the drying assembly is provided on the first fixing piece 31, and the first fixing piece 31 is provided with a second gas inlet connection 32 and a gas outlet connection 33; the drying pipe assembly further comprises a first gas inlet connection 15, a gas outlet end of the first gas inlet connection 15 is communicated with a gas inlet end of the gas channel 11, the gas outlet connection 33 is connected with a gas inlet end of the first gas inlet connection 15, the second gas inlet connection 32 is connected with a gas feed end, and the gas feed end is used for feeding the target gas to the drying device; and the gas outlet connection 33 is also provided with a valve 34, and the valve 34 is used for regulating a gas flow passing through the gas outlet connection 33.

In some specific embodiments, the drying device may comprise a plurality of first fixing pieces 31, each of the first fixing pieces 31 corresponds to one second gas inlet connection 32 and a plurality of gas outlet connections 33, the one second gas inlet connection 32 may correspond to a plurality of gas outlet connections 33, the second gas inlet connections 32 each correspond to one valve 34, each of the first fixing pieces 31 may be detachably provided with a plurality of drying assemblies, the drying assemblies each correspond to one first gas inlet connection 15 and one gas outlet connection 33, and a gas pump (not shown) may be connected between the second gas inlet connection 32 and the gas feed end to pump the target gas into the drying device from the gas feed end. Specifically, one of the first fixing piece 31 and each drying assembly is provided with a protrusion structure, and the other is provided with a corresponding recess structure, which are convenient for installation and enable detachable connection between the drying assemblies and the first fixing piece 31. The inner wall of the first casing 61 may be provided with a mounting structure corresponding to a mounting end of the first fixing piece 31.

Specifically, a plurality of channels may be arranged in the first fixing piece 31, each of the channels is a channel between the second gas inlet connection 32 and each of the gas outlet connections 33 on the first fixing piece 31, and the channels are used for conveying the target gas from the second gas inlet connection 32 to each of the gas outlet connections 33. After that, the target gas may be further conveyed to the first gas inlet connection 15 and then conveyed to the sample container 64 through the gas channel 11.

Specifically, the specific shape and structure of the first fixing piece 31 and the arrangement of the plurality of drying assemblies on the first fixing piece 31 may be configured according to the actual application requirements, so they are not limited herein.

In practical application, a flow rate and a flow velocity of the gas passing through the gas outlet connection 33 may be controlled by regulating the valve 34 corresponding to each of the gas outlet connections 33, so that the gas flow rate of each of the gas outlet connections 33 meets the experimental requirements. For example, for the first fixing piece 31 and the plurality of gas outlet connections 33 arranged thereon, the gas flow passing through the gas outlet connections 33 gradually decreases with increase of the length of the gas channel 11. Hence, in the above process, the flow rate and the flow velocity of the gas passing through the gas outlet connections 33 may be controlled by regulating the valve 34 corresponding to each of the gas outlet connections 33, so that the differential of gas flows passing through different gas outlet connections 33 is less than the preset flow threshold. That is, the gas flow passing through each of the gas outlet connections 33 is substantially the same, so as to avoid the problems of excessive gas regulation, sample splashing out of the bottle, and inconsistent blow-drying degree caused by significant differential of gas flow at the gas outlet. Specifically, the preset flow threshold may be set according to practical application requirements.

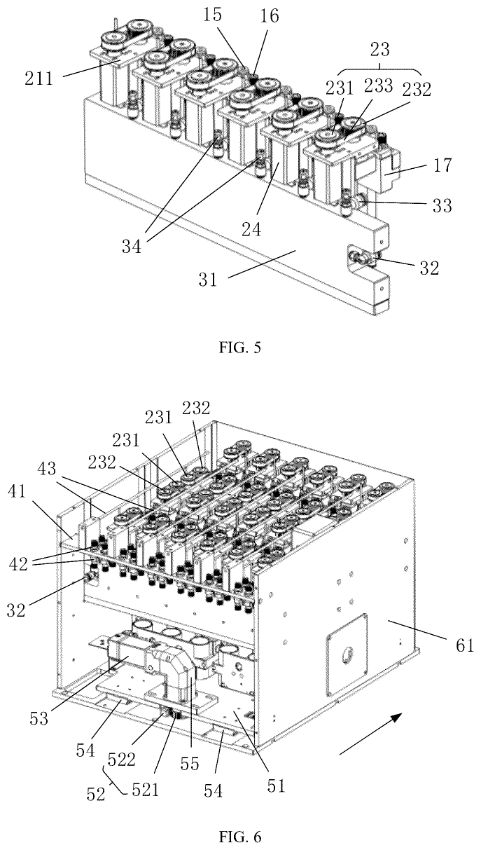

Optionally, as shown in FIG. 6, the drying device further comprises a second fixing piece 41, the second fixing piece 41 is provided on the inner wall of the first casing 61, and the second fixing piece 41 is provided with a connecting head 42; and the drying pipe assembly further comprises a liquid inlet connection 16 and a second liquid channel 13, a liquid outlet end of the second liquid channel 13 is communicated with a liquid inlet end of the first liquid channel 12, a liquid inlet end of the second liquid channel 13 is communicated with one end of the liquid inlet connection 16, one end of the connecting head 42 is connected with the other end of the liquid inlet connection 16, and the other end of the connecting head 42 is connected with a feed end of the target liquid.

Specifically, the second fixing piece 41 may be provided with a plurality of connecting heads 42, the connecting heads 42 each correspond to one liquid inlet connection 16, and the specific arrangement of the plurality of connecting heads 42 on the second fixing piece 41 may be determined according to the arrangement of the drying assemblies and the first fixing piece 31. The inner wall of the first casing 61 may be provided with a mounting structure corresponding to a mounting end of the second fixing piece 41.

Specifically, the second liquid channel 13 may be regarded as a branch pipeline communicated with the liquid inlet end of the first liquid channel 12, a liquid pump (not shown) may be provided between the feed end of the target liquid and the connecting head 42, so that the target liquid is obtained from the feed end by pumping, flows to the liquid inlet connection 16 of the drying pipe assembly through the connecting head 42, and then enters the first liquid channel 12 through the second liquid channel 13, and flows to the liquid outlet end of the first liquid channel 12. After being pressurized under the guidance of the liquid guiding member 14, the target liquid is dispersed and sprayed onto an inner wall of the sample container 64 from between the liquid guiding member 14 and the liquid channel casing 102 (namely, the liquid guide channel 141) in the direction indicated by the guide portion, so as to achieve the effect of dissolving the sample attached to the inner wall of the sample container 64.

Specifically, the connecting head 42 is connected with the feed end of the target liquid and the liquid inlet connection 16 through a pipeline individually, and the second fixing piece 41 is provided with a wire winding rod 43, so that the pipeline between the connecting head 42 and the liquid inlet connection 16 and wires in the device are capable of being arranged on the wire winding rod 43 to fix the lines and avoid the intertwining and interference of the lines.

Specifically, the drying pipe assembly may further comprise an installation protection structure 17. The gas outlet end of the first gas inlet connection 15, the gas inlet end of the gas channel 11, the liquid outlet end of the liquid inlet connection 16, the liquid inlet end of the first liquid channel 12 and the liquid outlet end of the second liquid channel 13 are all arranged inside the installation protection structure 17, and the gas inlet end of the first gas inlet connection 15, the gas outlet end of the gas channel 11 and the liquid inlet end of the liquid inlet connection 16 are all arranged outside the installation protection structure 17. A sealing structure (e.g., O-ring) may be provided at the connection between the second gas inlet connection 15 and the gas channel 11 as well as the connection between the liquid inlet connection 16 and the second liquid channel 13 to play a sealing role.

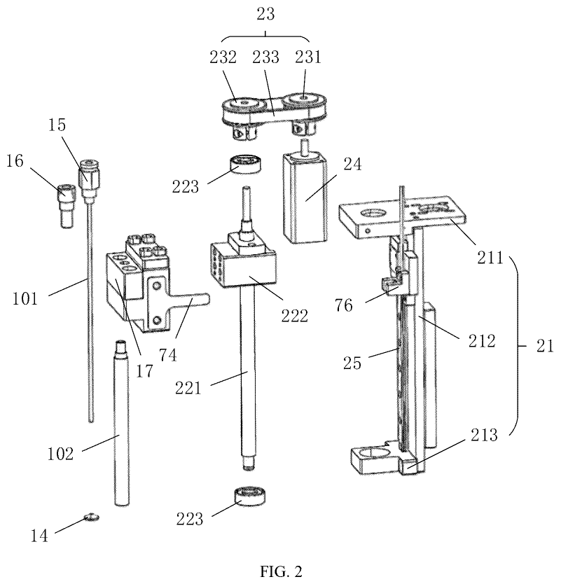

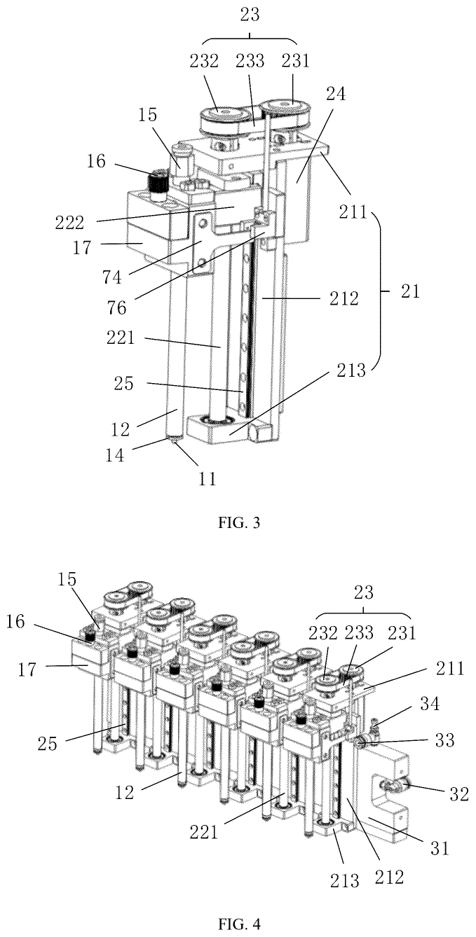

In some alternative embodiments, as shown in FIGS. 2 and 3, the drying assembly further comprises a fixing assembly 21, a driving device and the first fixing piece 31, the fixing assembly 21 is provided on the first fixing piece 31, the driving device is connected with the drying pipe assembly, and a guide part 25 is provided on the fixing assembly 21; and the driving device is used for driving the drying pipe assembly to move along the guide part 25.

Optionally, the driving device comprises a first moving assembly, a first transmission assembly 23 and a first driving mechanism 24, the first moving assembly is connected with the drying pipe assembly, the first transmission assembly 23 is provided at one end of the first moving assembly, and the first moving assembly is in driving connection with the first driving mechanism 24 through the first transmission assembly 23; the first moving assembly comprises a drive rod 221, a moving part 222 and a connecting part 223, the moving part 222 is connected with the drying pipe assembly, the first transmission assembly 23 is provided at one end of the drive rod 221, the moving part 222 is sleeved on the drive rod 221, the connecting part 223 is connected with the fixing assembly 21, the connecting part 223 is provided at either end of the drive rod 221, and the connecting part 223 is rotationally connected with the drive rod 221; and the first driving mechanism 24 is used for driving the moving part 222 to move along the guide part 25, so as to drive the drying pipe assembly to move; and the first transmission assembly 23 comprises a transmission wheel, the transmission wheel is provided at one end of the drive rod 221, the drive rod 221 is in driving connection with the first driving mechanism 24 through the transmission wheel, and the transmission wheel and the connecting part 223 are coaxially arranged with the drive rod 221.

In some specific embodiments, the connecting part 223 may be one connecting part 223 located at the top of the drive rod 221, or may comprise two connecting parts 223 respectively located at the top and the bottom of the drive rod 221. Specifically, the connecting part 223 may be a bearing, and the connecting part 223 is connected with the fixing assembly 21 and the drive rod 221.

Specifically, the fixing assembly 21 may comprise a fourth fixing piece 211, a fifth fixing piece 212 and a sixth fixing piece 213. In the case of having two connecting parts 223 respectively located at the top and the bottom of the drive rod 221, the first driving mechanism 24 and the connecting part 223 located at one end of the drive rod 221 that is connected with the transmission wheel (namely, the connecting part 223 located at the top of the drive rod 221) are connected with the fourth fixing piece 211, the connecting part 223 located at the other end of the drive rod 221 (namely, the connecting part 223 located at the bottom of the drive rod 221) is connected with the sixth fixing piece 213, and the guide part 25 is provided on the fifth fixing piece 212. Specifically, the moving part 222 may have a nut structure corresponding to the drive rod 221, or comprise a nut structure and a fixing structure sleeved on the nut structure.

In practical application, under the control of a host computer program, with decrease of a liquid level, the first driving mechanism 24 powers the transmission wheel to drive the moving part 222 to move downwards along the guide part 25, so that the drying pipe assembly in fixed connection with the moving part 222 synchronously moves downwards to a position at a preset distance from the liquid level, thereby improving the rationality of drying treatment and the drying efficiency. The preset distance may be set according to practical application requirements. In some embodiments, the drying device may further comprise a liquid level sensor, which is capable of being used to sense the liquid level of the liquid sample in the sample container 64, so that the drying pipe assembly is driven to synchronously move downwards to the position at the preset distance from the liquid level as the liquid level decreases.

Optionally, the transmission wheel comprises a driving wheel 231 and a driven wheel 232, and the first transmission assembly 23 further comprises a transmission belt 233, the driven wheel 232 is provided at one end of the drive rod 221, the driving wheel 231 is in driving connection with the first driving mechanism 24, the driven wheel 232 and the connecting part 223 are coaxially arranged with the drive rod 221, the driving wheel 231 and the driven wheel 232 are horizontally arranged, and the transmission belt 233 is wound on outer sides of the driving wheel 231 and the driven wheel 232. Specifically, the driven wheel and the connecting part 223 are in wheel-shaped structures and are coaxially arranged with respect to a center-to-center line thereof, and the drive rod 221 is located in the axial direction of the center-to-center line of the driven wheel and the connecting part 223.

Optionally, as shown in FIGS. 2 and 3, the drying device further comprises a first sensing element 74 and a first sensor 76, at least one of the first sensing element 74 and the first sensor 76 is provided on the drying assembly, and the other is provided on the fixing assembly 21, and the first sensing element 74 and the first sensor 76 are correspondingly arranged; and the first sensing element 74 and the first sensor 76 are used for sensing that the drying pipe assembly is located at a first preset position.

Specifically, the first sensing element 74 is provided on the drying assembly, and the first sensor 76 is provided on the fixing assembly 21. The first sensing element 74 may be a sensing sheet, and the first sensor 76 may be a photoelectric sensor (e.g., groove-type photoelectric sensor). The sensing sheet of the first sensing element 74 is capable of being provided on the installation protection structure 17 of the drying pipe assembly, and the first sensor 76 is capable of being provided on the fixing assembly 21 (e.g., the fifth fixing piece 212). Through the cooperation between the sensing sheet and the sensor, when passing through the photoelectric sensor, the sensing sheet blocks the light beam and triggers an ‘off’ state of the photoelectric sensor, which corresponds to the fact that the drying pipe assembly is located at the first preset position. Specifically, the first preset position may be an upper limit position accessible to the drying pipe assembly.

Optionally, as shown in FIGS. 6 and 7, the drying device further comprises a second moving assembly and a receiving cell 63, the second moving assembly comprises a moving plate 51, a second transmission assembly 52 and a second driving mechanism 53, the moving plate 51 is provided inside the first casing 61, the receiving cell 63 is provided on the moving plate 51, the receiving cell 63 is used for placing the sample container 64, the moving plate 51 is in driving connection with the second driving mechanism 53 through the second transmission assembly 52, a slideway 54 is provided in the bottom of the first casing 61, and the second driving mechanism 53 is used for driving the moving plate 51 to slide along the slideway 54; and the second transmission assembly 52 comprises a gear 521 and a rack 522, the gear 521 is in driving connection with the second driving mechanism 53, the rack 522 is provided in the bottom of the first casing 61, and the gear 521 is engaged with the rack 522.

Specifically, the rack 522 and the slideway 54 are arranged in parallel on a bottom plate of the first casing 61. Through the second transmission assembly 52, the second driving mechanism 53 and the slideway 54, the moving plate 51 may move along the slideway 54 to achieve the push-pull effect (as shown in FIG. 6, the moving plate is pulled out in the direction as indicated by the arrow), which is convenient for the operator to take, and also achieves taking and placing the sample container 64 through a manipulator. A reducing mechanism 55 may also be provided between the second driving mechanism 53 and the second transmission gear 521 to improve the stability of the moving plate 51 during movement.

Specifically, as shown in FIGS. 4 to 7, the drying device may be provided with a plurality of drying assemblies and a plurality of receiving cells 63, the receiving cells 63 each may accommodate one sample container 64, the drying assemblies each correspond to one sample container 64, the drying assemblies each may comprise one drying pipe assembly, and each of the drying pipe assemblies is used for drying and spraying a sample in the one sample container 64 in the corresponding receiving cell 63 to concentrate and purify the sample in the sample container 64. Specifically, the different receiving cells 63 and the sample containers 64 placed therein may be of the same specification or a combination of different specifications. Each of the drying assemblies is capable of being assembled independently. Hence, in case of a failure, a fault assembly may be replaced separately for convenient maintenance.

In some embodiments, as shown in FIG. 7, the drying device further comprises a second sensing element 75 and a second sensor 77, at least one of the second sensing element 75 and the second sensor 77 is provided on the moving plate 51, the other is provided on the inner wall of the first casing 61, and the second sensing element 75 and the second sensor 77 are correspondingly arranged; and the second sensing element 75 and the second sensor 77 are used for sensing that the moving plate 51 is located at a second preset position.

Specifically, the second sensing element 75 may be provided on the moving plate 51, and the second sensor 77 may be provided on the inner wall of the first casing 61. Refer to the first sensing element 74 and the first sensor 76 for their specific working principle, which is not described here. The second preset position may be the maximum moving position accessible to the moving plate 51.

In some alternative embodiments, as shown in FIG. 7, the drying device further comprises a heating device 8, the heating device 8 is provided on the receiving cell 63, and the heating device 8 is used for heating the sample container accommodated in the receiving cell 63.

Specifically, when receiving a heating signal, the heating device 8 starts to heat the sample container 64. The drying efficiency is improved by controlling the temperature of the heated container. The heating device 8 may comprise a fixing base and a heating structure provided in the fixing base, such as an electric heating rod and a water-bath heating structure. The specific configuration of the heating structure is related to the sample type. In order not to deteriorate the physical and chemical properties of the sample to be dried, the heating device 8 is capable of being set to different heating temperatures according to the situation of the sample to be dried.

In practical application, it is necessary to conduct condensation recovery on a gaseous organic solvent volatilized during the drying process. By lowering a temperature of an organic gas, the heat of the gas is removed, so that the organic gas is converted into liquid.

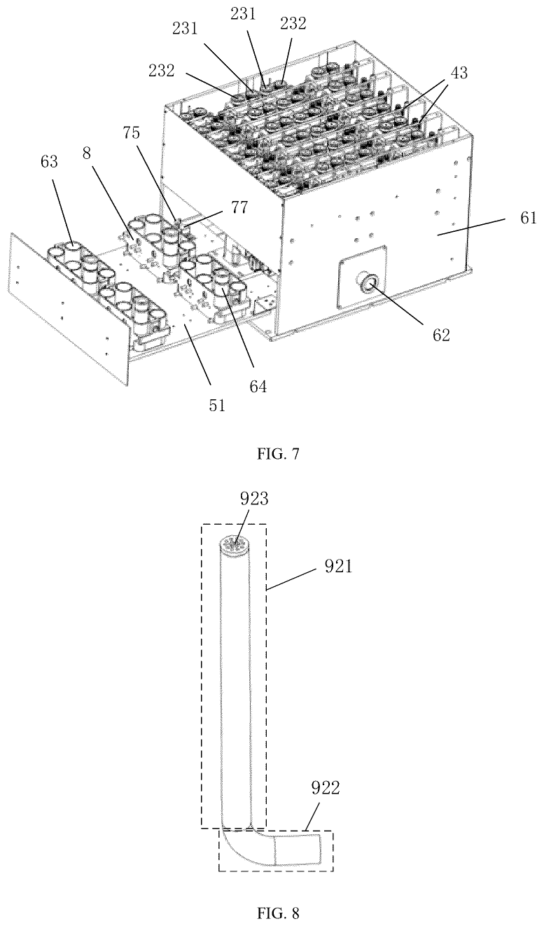

One embodiment of the present application also provides a drying system, referring to FIGS. 8 to 10, which comprises a recovery device and the drying device, the first casing 61 is configured with a connecting port 62, and the recovery device is communicated with the drying device through the connecting port 62; the recovery device comprises a third gas inlet connection 91, a power transmission device and a second casing 95, the third gas inlet connection 91 is communicated with the connecting port 62, the third gas inlet connection 91 is provided on an outer side of the second casing 95, one end of the power transmission device is provided inside the second casing 95, and the other end of the power transmission device is provided outside the second casing 95; and the power transmission device is provided with a cellular structure 923 at the end located inside the second casing 95; and the third gas inlet connection 91 is used for conveying an organic gas produced in the drying device into the second casing 95, the power transmission device is used for providing power for the flow of the organic gas, and the cellular structure 923 is used for stabilizing the gas flow in the second casing 95.

Optionally, as shown in FIG. 8, the power transmission device comprises a vacuum pipe 92 and a vacuum pump (not shown), the vacuum pipe 92 comprises a first portion 921 and a second portion 922, the first portion 921 is provided inside the second casing 95, the second portion 922 passing through the second casing 95 is connected with the vacuum pump, and one end of the first portion 921 that is far away from the second portion 922 is provided with the cellular structure 923; and the vacuum pipe 92 is an L-shaped pipe.

Specifically, the recovery device is used for condensing, liquefying and recovering the gaseous organic solvent volatilized during the drying process, the third gas inlet connection 91 is used for conveying the organic gas (namely, the gaseous organic solvent) produced in the drying device into the second casing 95, and the cellular structure 923 is used for stabilizing the gas flow in the second casing 95. The cellular structure 923 is configured with an edge lower than a center portion, which is capable of limiting the flow direction of the condensate. In practical application, the third gas inlet connection 91 is located at the bottom of the second casing 95, and the vacuum pipe 92 is located at the top of the second casing 95 at one end inside the second casing 95, so that the vacuum pipe 92 is capable of being used to provide power for the upward flow of the gas in the third gas inlet connection 91 during the vacuum process, avoiding pumping the gas into the vacuum pump.

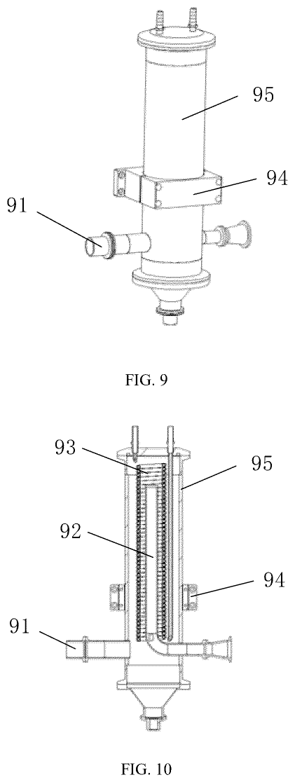

In some embodiments, as shown in FIGS. 9 and 10, the recovery device further comprises a condensing structure 93, a receiving structure and a third fixing piece 94, the condensing structure 93 is provided inside the second casing 95, the receiving structure is provided below the second casing 95, the third fixing piece 94 is sleeved on the second casing 95, the third fixing piece 94 is in fixed connection with an outer side of the first casing 61, and one end of the power transmission device is provided inside the condensing structure 93; and the condensing structure 93 is used for condensing the organic gas in the second casing 95 into liquid, and the receiving structure is used for receiving the liquid formed by condensation.

In some specific embodiments, the condensing structure 93 may be a condensation pipe, such as a condensing coil. By coiling up and stacking layer by layer, the pipe covers a small floor area, thus effectively increasing the contact area between the unit area and the organic gas and improving the condensation efficiency. The receiving structure may be configured according to practical application requirements, such as a reaction flask.

In practical application, the organic gas generated in the drying device enters the recovery device through the connecting port 62 and the third gas inlet connection 91, the vacuum pump starts to vacuum the interior of the recovery device casing through the L-shaped pipe. Under the action of the vacuum pressure by the vacuum pump, the organic gas moves upward, and condenses after cooling by contacting with the condensing coil. The condensate flows down to the receiving structure below the casing along the inner wall of the casing or an outer wall of the coil. When the liquid level in the receiving structure reaches the preset position, a sealing valve provided at the bottom of the receiving structure is opened to allow the liquid to flow out, and then the sealing valve is closed to continue the recovery operation. The preset position may be set according to practical application requirements.

Optionally, the drying system further comprises a control module (not shown), the control module is electrically connected with the first driving mechanism 24, the second driving mechanism 53, the heating device 8, the gas pump, the liquid pump, the vacuum pump and the valve 34.

In the above embodiments, the recovery process and the drying process are automatically and seamlessly connected to improve the production efficiency. In addition, according to the sample properties, the corresponding coil may be configured to complete the condensation recovery operation, which is simple in structure and easy for processing and assembly, and has high concentration and small floor area.

In the above embodiments, the fixed connection comprises a detachable connection and a non-detachable connection, such as threaded connection and integral connection.

One embodiment of the present application also provides a drying method based on the drying system, and the method comprises the following steps:
conveying the target gas to the sample container 64 of the drying device along the gas channel 11 to blow the sample container 64 of the sample;
during the blowing process, conveying the target liquid to the sample container 64 along the first liquid channel 12 and the liquid guide channel 141, so as to dissolve the sample attached to the inner wall of the sample container 64; and
during the blowing process, conveying the organic gas produced in the drying device into the second casing 95 through the power transmission device of the recovery device, the connecting port 62 of the drying device and the third gas inlet connection 91 of the recovery device; and condensing the organic gas into liquid through the condensing structure 93, and receiving the liquid formed by condensation through the receiving structure; and the power transmission device is provided with the cellular structure 923 at one end located inside the second casing 95.

Specifically, a control process of drying sample based on the drying system is described below, comprising the following steps:
When the drying operation is required, the second driving mechanism 53 is controlled to drive the moving plate 51 to move out of the first casing 61, and the moving plate 51 is loaded with the receiving cell 63 and the heating device 8. During the process, the reducing mechanism 55 is controlled to regulate the running state of the second driving mechanism 53 (e.g., reducing the rotation speed of the second driving mechanism 53 and increasing the torque), thereby improving the response speed and accuracy, and improving the accuracy and stability of the moving plate 51. Then the manipulator is controlled to grasp the sample container 64 containing the sample to be dried and place it in the receiving cell 63. After all the sample containers are placed, the second driving mechanism 53 is controlled to pull back the moving plate 51, and the heating device 8 is controlled to heat the sample containers 64. At the same time, the gas pump may be controlled to blow gas into the sample containers 64, and the gas sequentially passes through the second gas inlet connection 32, the first fixing piece 31, the gas outlet connection 33, the first gas inlet connection 15 and the gas channel 11. During the process, the valve 34 on the gas outlet connection 33 is controlled to regulate the flow rate and the flow velocity of the gas passing through the gas outlet connection 33 to meet the gas demand for the drying operation.

In the process of continuously blowing gas into the sample containers 64, the first driving mechanism 24 is controlled to drive the drying pipe assembly to descend with the liquid level, and a distance is kept between the bottom of the drying pipe and the liquid level. In addition, the liquid for spraying is pumped by the liquid pump to sequentially pass through the connecting head 42, the liquid inlet connection 16, the second liquid channel 13 and the first liquid channel 12, and flow to the liquid outlet end of the first liquid channel 12 through the area between the first liquid channel 12 and the gas channel 11. After being pressurized under the guidance of the liquid guiding member 14, the liquid is dispersed and sprayed onto inner walls of the sample containers 64 from between the liquid guiding member 14 and the liquid channel casing 102 (namely, the liquid guide channel 141) in the direction indicated by the guide portion, so as to achieve the effect of dissolving the sample attached to the inner walls of the sample containers 64. The drying and spraying processes above are repeated constantly until the drying requirements are met, so as to ensure that the samples are not brought out by blow-drying and retained in the bottom of the containers to the maximum extent.

In the drying process, the vacuum pump is connected with the vacuum pipe 92 to vacuum the interior of the recovery device casing. Under the action of the vacuum pressure, the gaseous organic solvent volatilized by the drying operation enters the recovery device from the drying device through the connecting port 62 and the third gas inlet connection 91, moves upward, and condenses after cooling by contacting with the condensing structure 93. The condensate flows down to the receiving structure below the casing along the inner wall of the casing or the outer wall of the coil. When the liquid level in the receiving structure reaches the preset position, the sealing valve provided at the bottom of the receiving structure is opened to allow the liquid to flow out, and then the sealing valve is closed to continue the recovery operation.

After the drying process is completed, the second driving mechanism 53 is controlled to drive the moving plate 51 to move out, and the manipulator is controlled to take out the dried sample container for the next operation process.

One embodiment of the present application also provides a synthetic reaction system, which comprises the drying system.

Specifically, the drying system is suitable for blow-drying and condensation operations in various scenes, and may be used for pharmaceutical chemistry and synthesis, environmental analysis, biological analysis and the like.

According to the technical solutions provided by the embodiments in the Description, a drying device in the Description is used for processing a sample in a sample container, the drying device comprises a drying assembly and a first casing, the drying assembly is provided inside the first casing, the sample container is placed inside the first casing, and the drying assembly is located above the sample container. Wherein the drying assembly comprises a drying pipe assembly, the drying pipe assembly comprises a gas channel, a first liquid channel and a liquid guide channel, the gas channel is used for conveying a target gas to the sample container, the first liquid channel and the liquid guide channel are used for conveying a target liquid to the sample container, the liquid guide channel is used for indicating an output direction of the target liquid to the sample container, and the gas channel passes through the first liquid channel; and along a flow direction of the target liquid, the first liquid channel and the liquid guide channel are arranged in sequential communication, the target gas is used for blowing the sample container of the sample, and the target liquid is used for dissolving the sample attached to an inner wall of the sample container. During the process of drying the sample in the sample container based on the drying device, the target gas is conveyed to the sample container to dry the sample therein through the gas channel in the drying pipe assembly, the target liquid flows to the liquid guide channel through the first liquid channel, and is dispersed and sprayed to the sample container along an output direction indicated by the liquid guide channel after being pressurized through the liquid guide channel, so as to dissolve the sample attached to the inner wall of the sample container during the drying process and clean the inner wall of the container. Additionally, the dissolved sample will flow to the bottom of the sample container for the next drying operation, so that the sample is not taken out during the drying process, and the dried sample is retained in the bottom of the sample container to the maximum extent. In this way, the drying effectiveness and efficiency are improved, and cross contamination among components such as gas channels and liquid channels is avoided.

Those of ordinary skill in the art can understand that all or some of steps in the above embodiments can be fulfilled by hardware or by programs commanding relevant hardware. The described program can be stored in a computer readable storage medium which can be ROM, disk or CD.

Only preferred embodiments of the present application are described above, but the present application is not limited thereto. Any modification, equivalent replacement and improvement made within the spirit and principle of the present application shall be incorporated in the scope of protection of the present application.

What is claimed is:

1. A drying device, which is used for processing a sample in a sample container, the drying device comprises a drying assembly and a first casing, the drying assembly is provided inside the first casing, the sample container is placed inside the first casing, and the drying assembly is located above the sample container;
the drying assembly comprises a drying pipe assembly, the drying pipe assembly comprises a gas channel, a first liquid channel and a liquid guide channel, the gas channel is used for conveying a target gas to the sample container, the first liquid channel and the liquid guide channel are used for conveying a target liquid to the sample container, the liquid guide channel is used for indicating an output direction of the target liquid to the sample container, and the gas channel passes through the first liquid channel; along a flow direction of the target liquid, the first liquid channel and the liquid guide channel are arranged in sequential communication; and
the target gas is used for blowing and drying the sample in the sample container, and the target liquid is used for dissolving the sample attached to an inner wall of the sample container.

2. The drying device according to claim 1, the drying device further comprises a first fixing piece, the first fixing piece is provided on an inner wall of the first casing, the drying assembly is provided on the first fixing piece, and the first fixing piece is provided with a second gas inlet connection and a gas outlet connection;
the drying pipe assembly further comprises a first gas inlet connection, a gas outlet end of the first gas inlet connection is communicated with a gas inlet end of the gas channel, the gas outlet connection is connected with a gas inlet end of the first gas inlet connection, the second gas inlet connection is connected with a gas feed end, and the gas feed end is used for feeding the target gas to the drying device; and
the gas outlet connection is also provided with a valve, and the valve is used for regulating a gas flow passing through the gas outlet connection.

3. The drying device according to claim 1, the drying device further comprises a second fixing piece, the second fixing piece is provided on an inner wall of the first casing, and the second fixing piece is provided with a connecting head; and
the drying pipe assembly further comprises a liquid inlet connection and a second liquid channel, a liquid outlet end of the second liquid channel is communicated with a liquid inlet end of the first liquid channel, a liquid inlet end of the second liquid channel is communicated with one end of the liquid inlet connection, one end of the connecting head is connected with the other end of the liquid inlet connection, and the other end of the connecting head is connected with a feed end of the target liquid.

4. The drying device according to claim 1, the drying device further comprises a gas channel casing, a liquid channel casing and a liquid guiding member, the gas channel casing forms the gas channel, and the first liquid channel is formed between the gas channel casing and the liquid channel casing, the liquid channel casing and the liquid guiding member are sequentially arranged, spaced apart from each other on the gas channel casing, the liquid guiding member is provided on the gas channel and closes to a gas outlet end of the gas channel, and the liquid guide channel is formed between the liquid channel casing and the liquid guiding member; and
the liquid guiding member comprises a guide portion, the liquid guide channel is formed between the liquid channel casing and the guide portion, and the guide portion has a shape of a frustum of a cone.

5. The drying device according to claim 1, the drying assembly further comprises a fixing assembly, a driving device and a first fixing piece, the fixing assembly is provided on the first fixing piece, the driving device is connected with the drying pipe assembly, and a guide part is provided on the fixing assembly; and the driving device is used for driving the drying pipe assembly to move along the guide part.

6. The drying device according to claim 5, the driving device comprises a first moving assembly, a first transmission assembly and a first driving mechanism, the first moving assembly is connected with the drying pipe assembly, the first transmission assembly is provided at one end of the first moving assembly, and the first moving assembly is in driving connection with the first driving mechanism through the first transmission assembly;
the first moving assembly comprises a drive rod, a moving part and a connecting part, the moving part is connected with the drying pipe assembly, the first transmission assembly is provided at one end of the drive rod, the moving part is sleeved on the drive rod, the connecting part is connected with the fixing assembly, the connecting part is provided at either end of the drive rod, and the connecting part is rotationally connected with the drive rod; and the first driving mechanism is used for driving the moving part to move along the guide part, so as to drive the drying pipe assembly to move; and
the first transmission assembly comprises a transmission wheel, the transmission wheel is provided at one end of the drive rod, the drive rod is in driving connection with the first driving mechanism through the transmission wheel, and the transmission wheel and the connecting part are coaxially arranged with the drive rod.

7. The drying device according to claim 6, the transmission wheel comprises a driving wheel and a driven wheel, and the first transmission assembly further comprises a transmission belt, the driven wheel is provided at one end of the drive rod, the driving wheel is in driving connection with the first driving mechanism, the driven wheel and the connecting part are coaxially arranged with the drive rod, the driving wheel and the driven wheel are horizontally arranged, and the transmission belt is wound on outer sides of the driving wheel and the driven wheel.

8. The drying device according to claim 5, the drying device further comprises a first sensing element and a first sensor, one of the first sensing element and the first sensor is provided on the drying assembly, and the other is provided on the fixing assembly, and the first sensing element and the first sensor are correspondingly arranged; and the first sensing element and the first sensor are used for sensing that the drying pipe assembly is located at a first preset position.

9. The drying device according to claim 1, the drying device further comprises a second moving assembly and a receiving cell, the second moving assembly comprises a moving plate, a second transmission assembly and a second driving mechanism, the moving plate is provided inside the first casing, the receiving cell is provided on the moving plate, the receiving cell is used for placing the sample container, the moving plate is in driving connection with the second driving mechanism through the second transmission assembly, a slideway is provided in a bottom of the first casing, and the second driving mechanism is used for driving the moving plate to slide along the slideway; and
the second transmission assembly comprises a gear and a rack, the gear is in driving connection with the second driving mechanism, the rack is provided in the bottom of the first casing, and the gear is engaged with the rack.

10. The drying device according to claim 9, the drying device further comprises a second sensing element and a second sensor, one of the second sensing element and the second sensor is provided on the moving plate, the other is provided on the inner wall of the first casing, and the second sensing element and the second sensor are correspondingly arranged; and the second sensing element and the second sensor are used for sensing that the moving plate is located at a second preset position.

11. The drying device according to claim 9, the drying device further comprises a heating device, the heating device is provided on the receiving cell, and the heating device is used for heating the sample container accommodated in the receiving cell.

12. A drying system, comprising a recovery device and the drying device according to claim 1, the first casing is configured with a connecting port, and the recovery device is communicated with the drying device through the connecting port;
the recovery device comprises a third gas inlet connection, a power transmission device and a second casing, the third gas inlet connection is communicated with the connecting port, the third gas inlet connection is provided on an outer side of the second casing, one end of the power transmission device is provided inside the second casing, and the other end of the power transmission device is provided outside the second casing; and the power transmission device is provided with a cellular structure at the end located inside the second casing; and
the third gas inlet connection is used for conveying an organic gas produced in the drying device to the second casing, the power transmission device is used for providing power for the flow of the organic gas, and the cellular structure is used for stabilizing the gas flow in the second casing.

13. The drying system according to claim 12, the power transmission device comprises a vacuum pipe and a vacuum pump, the vacuum pipe comprises a first portion and a second portion, the first portion is provided inside the second casing, the second portion passing through the second casing is connected with the vacuum pump, and one end of the first portion that is far away from the second portion is provided with the cellular structure; and the vacuum pipe is an L-shaped pipe.

14. The drying system according to claim 12, the recovery device further comprises a condensing structure, a receiving structure and a third fixing piece, the condensing structure is provided inside the second casing, the receiving structure is provided below the second casing, the third fixing piece is sleeved on the second casing, the third fixing piece is in fixed connection with an outer side of the first casing, and one end of the power transmission device is provided inside the condensing structure; and
the condensing structure is used for condensing the organic gas in the second casing into liquid, and the receiving structure is used for receiving the liquid formed by condensation.

15. A drying method based on the drying system according to claim 14, the recovery device comprises the condensing structure and the receiving structure, and the method comprises the following steps:
conveying the target gas to the sample container of the drying device along the gas channel to blow the sample container of the sample;
during the blowing process, conveying the target liquid to the sample container along the first liquid channel and the liquid guide channel, so as to dissolve the sample attached to the inner wall of the sample container; and
during the blowing process, conveying the organic gas produced in the drying device to the second casing through the power transmission device of the recovery device, the connecting port of the drying device and the third gas inlet connection of the recovery device; and
condensing the organic gas into liquid through the condensing structure, and receiving the liquid formed by condensation through the receiving structure; and the power transmission device is provided with the cellular structure at one end located inside the second casing.

16. A synthetic reaction system, comprises the drying system according to claim 12.
